(19) United States
(12) Patent Application Publication
(10) Pub. No.: US 2005/0177993 A1
(43) Pub. Date: Aug. 18, 2005

(54) Method for mechanically joining two or more layers of sheet material

(76) Inventor: Hans R Bergkvist, Morges (CA)

Correspondence Address: MANELLI DENISON & SELTER, 2000 M STREET NW SUITE 700, WASHINGTON, DC, 20036-3307, US

(21) Appl. No.: 10/513,667

(22) PCT Filed: May 8, 2002
(86) PCT No.: PCT/EP02/05025

(51) Int. Cl. B23P 11/00; B21D 39/00

(52) U.S. Cl. 29/514; 29/505

(57) ABSTRACT

Method for mechanical joining two or more sheet formed members in which the sheet formed members are positioned overlapping over a die and a punch is moved in the direction of the die in order to draw the sheet formed material down into the die thereby forming a cup formed cavity. The punch axis is arranged to form an angle with the geomertical axis of the die. The punch creates a lateral expansion of the cup formed cavity which expansion takes place outside the die cavity.

### TECHNICAL FIELD

This invention relates to a method and apparatus for mechanically joining two or more layers of sheet material and/or profiles using a low force for creating the necessary permanent deformation of the members to be joined

### BACKGROUND ART

The method for joining overlapping sheet material and/or profiles through plastic deformation giving a mechanical interlocking of the members to be joined is known as clinching.

There are numerous variants of the principal clinching methods and numerous realisations of industrial equipment to create the mechanical interlocking exist.

In essence the clinching process is governed by the interplay of punch, die and anvil. These three elements are commonly referred to as a tool kit.

Punches come in various shapes, most commonly with round, rectangular or cruciform cross-section and so do the dies.

The dies generally feature moving walls, in neutral position held together with springs or elastomeric bands, or they feature fixed walls.

The anvil is the tool kit part against which the overlapping members are squeezed by the punch to create the interlocking. In some cases the anvil forms an integral part of the die cavity.

In such cases where the anvil position is fixed axially with respect to the die, this approach renders the performance of a specific tool kit highly dependent on deviations from a calibrated thickness of the members to be joined. This is particularly true when the die features fixed walls.

Generally speaking the interplay between punch and anvil takes the form of coaxial motion. While this to some extent renders the apparatus simple in geometry, the drawback is that the necessary forces for the squeezing become high, typically 35-50 kN. This in turn means that the structure carrying the punch on the one side and the mating die and anvil on the other side becomes heavy which is a nuisance if the apparatus is going to be robot- or handheld.

Recently realisations have been presented in which the punch interacts with the die featuring fixed or radially expandable wall segments, whereby the punch axis is describing a conical surface around the principal tool kit axis. These realisations are limited to dies and punches with circular cross-section and featuring anvils having a fixed axial position with respect to the die. While the necessary joining forces are strongly reduced in comparison to purely coaxial interplay between punch and anvil, the joint strength will depend strongly on the die cavity depth, i.e. the axial position of the fixed anvil with respect to the die.

In particular for use in general industry where material quality, coatings and thickness vary substantially from one lot of sheet material and profiles to another, as well as for installations for flexible manufacturing, it would be beneficial to remove or reduce these limitations.

### BRIEF DESCRIPTION OF THE INVENTION

The present invention is based on a separation of a pre-forming phase of the two or more overlapping members to be joined, in which the punch is made to move in relation to the principal tool kit axis, followed by a squeezing phase of the thus preformed material to create the clinch joint. Both in the pre-forming phase and the squeezing phase axial forces, not necessarily constant over time, are excerted on the punch.

This motion can be such that the punch axis describes a conical surface, not necessarily circular, not necessarily the same throughout the cycle and not necessarily associated with the punch turning around its own axis, or can be of more general nature. As an example of a simple motion pattern the punch could be made to pivot or slide around some point on its front surface in a plane through the principal tool kit axis, followed by motion in another plane through the tool kit axis etc. This approach would allow efficient, low-force pre-forming where the punch is non-rotary symmetric, for example having a rectangular cross-section.

The pre-forming phase takes place against a die with fixed or movable wall segments and in this phase the anvil does not play an active role. This means that the anvil may touch the lower sheet or there might be a space between the sheet and the anvil.

In the squeezing phase, the anvil is locked with respect to the die and the squeezing will take place between the punch, still moving in the relation to the principal tool kit axis, but not necessarily in the same pattern as in the pre-forming phase, and the thus locked anvil.

When the anvil is locked in a position flush with or protruding from the die, the squeezing will create a strong outwards flow of the material to be joined as it is no longer confined in the die, thus reinforcing the mechanical interlocking, in particular the pull-out strength, and creating a lower clinch but ton than if the joining takes place inside a fixed die cavity. As this process is essentially force controlled, it is obvious that the axial forces excerted in the squeezing phase can be tuned to the thickness of the material of the members to be joined, thereby rendering the invention universally applicable.

### BRIEF DESCRIPTION OF THE FIGURES

Other objects, uses and advantages of this invention will be apparent from the reading of this description which proceeds with reference to the accompanying drawings forming part thereof and wherein:

FIG. 1

FIG. 1 shows a cross-section of a typical clinched joint.

FIG. 2

FIG. 2 shows part of a cross-section through a joint illustrating certain joint parameters.

FIG. 3A-C

FIG. 3A-C show the initial position of the interacting tool parts, the pre-forming phase of the method and the squeezing phase according to one embodiment of the invention.

FIG. 4A-C

FIG. 4A-C show the initial position of the interacting tool parts, the pre-forming phase of the method and the squeezing phase according to a second embodiment of the invention.

FIG. 5A-C

FIG. 5A-C show the initial position of the interacting tool parts, the pre-forming phase of the method and the squeezing phase according to a third embodiment of the invention.

FIG. 6

FIG. 6 shows the invention applied to a machine of known type with a C-frame.

### DETAILED DESCRIPTION OF THE INVENTION

FIG. 1

FIG. 1 shows a cross-section of a typical clinched joint between two sheet formed members 10 and 11. Due to the lateral expansion of the material the two sheets have been fixed to each other.

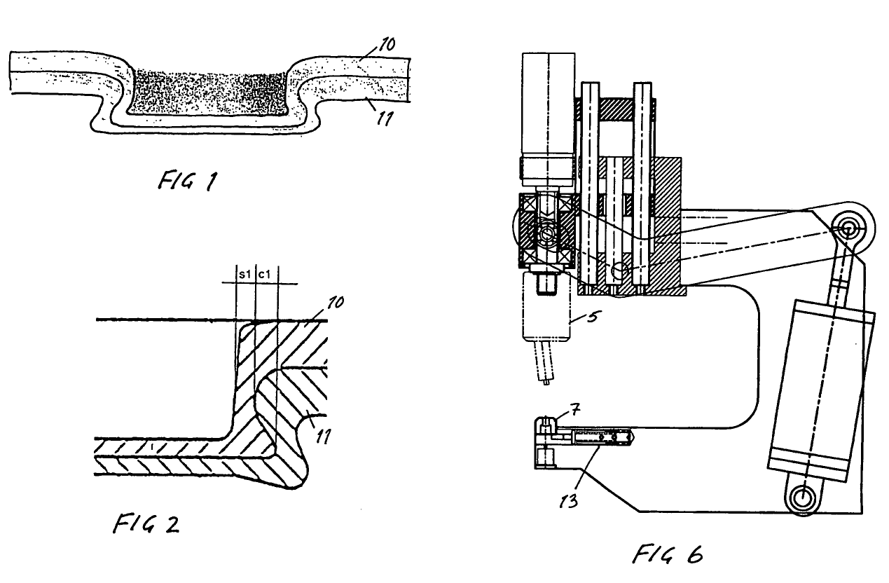

FIG. 2

FIG. 2 shows part of a cross-section through a joint illustrating certain joint parameters. A large s1 gives e.g. high shear strength and high strength for dynamic loads. A large c1 gives on the other hand high pull-out strength and high strength for static loads.

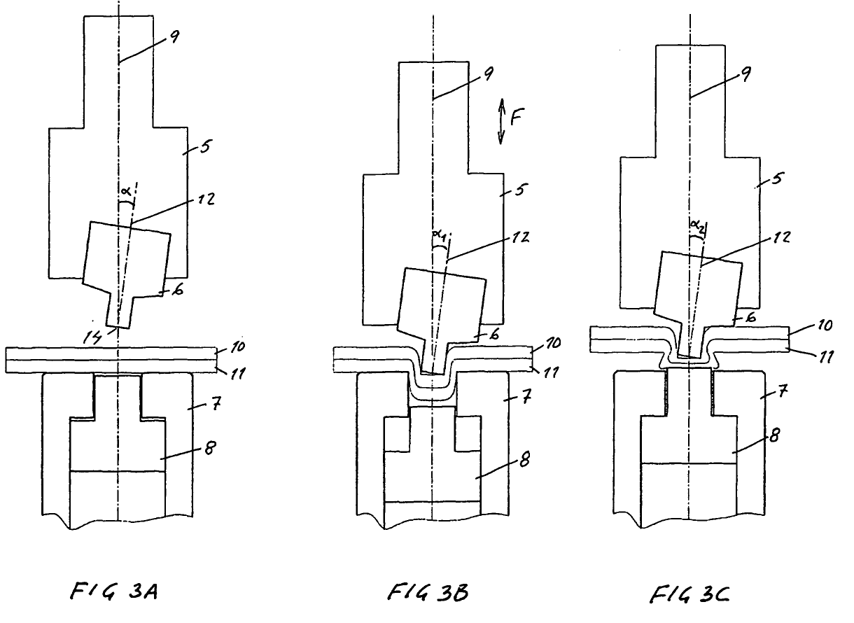

FIG. 3A-C

FIG. 3A-C show the initial position of the interacting tool parts, the pre-forming phase of the method and the squeezing phase respectively according to one embodiment of the invention.

A punch 6, a die 7 and an anvil 8 are arranged to cooperate by means of their relative movements along a main axis 9. The punch 6 is arranged on a punch holder 5 either fixed or freely rotating or driven by a motor (not shown).

FIG. 3A shows the initial position. The punch 6 has an axis 12 forming an angle a in the plane of the paper to the main axis 9. This means that the axis 9 and 12 are crossing each other in a point 14 in this case at the top of the punch 6.

In FIG. 3B the punch is drawing the material down into the die 7. The anvil is either retracted or just following the movement of the material down into the hole. The angle al does not have to be the same as the angle a. It should be noted that the punch holder is rotating during this movement. The punch could be just following freely rotatable in the punch holder or be rotated by means of a motor. This could e.g. be of advantage if it is suitable to create heat during the forming process. The double arrow F represents the applied forces which do not have to be constant during the process.

In the third step the anvil 8 has been activated and been given a vertical movent which lifts the preformed sheets out of the die. A new approach of the punch holder towards the die will now squeeze the material in the two sheets to create a lateral flow of material which very efficiently creates the desired mushrom shape which makes the joint. This lateral flow of material is much more efficient than in prior art arrangements in which the squeezing takes place inside a fixed die or a die with flexible side walls.

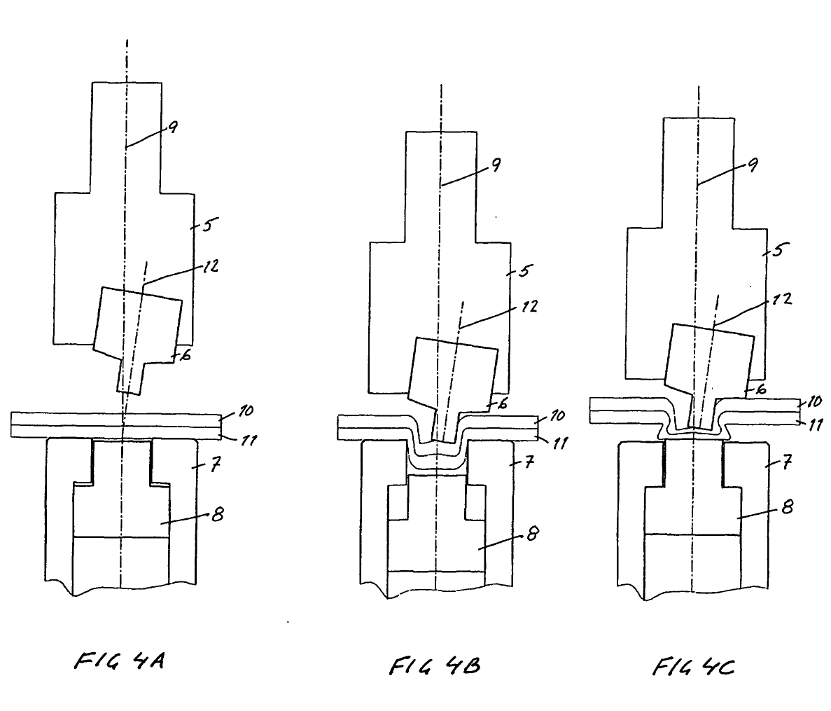

FIG. 4A-C

FIG. 4A-C show the initial position of the interacting tool parts, the pre-forming phase of the method and the squeezing phase according to a second embodiment of the invention.

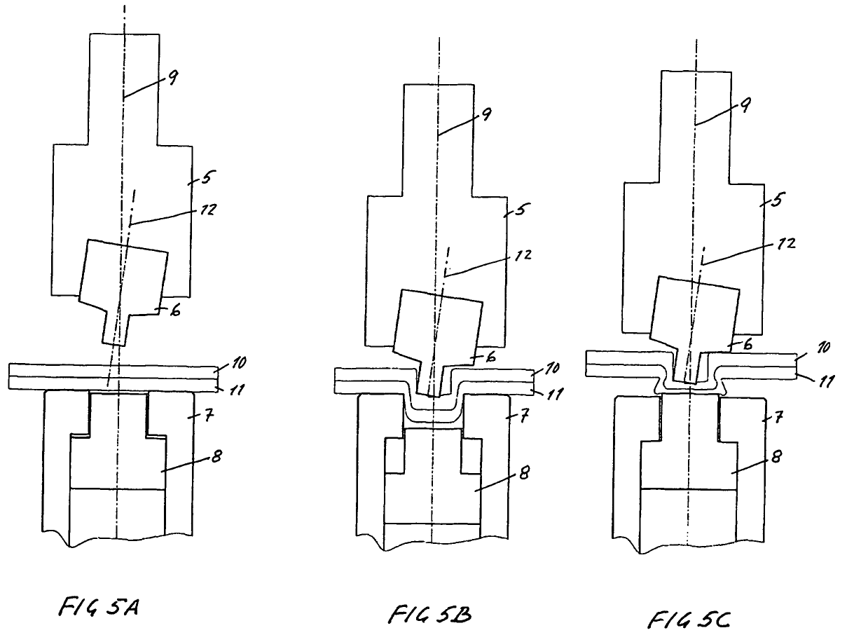

In this embodiment the axis 12 is crossing the axis 9 in a point which is situated below the top of the punch in the figure. This means that the pre forming and the squeezing phases will get the form shown in FIGS. 5B and 5C.

FIG. 5A-C

FIG. 5A-C show the initial position of the interacting tool parts, the pre-forming phase of the method and the squeezing phase according to a third embodiment of the invention.

In this embodiment the axis 12 is crossing the axis 9 in a point which is situated above the top of the punch in the figure. This means that the pre forming and the squeezing phases will get the form shown in FIGS. 5B and 5C.

In FIGS. 4 and 5 the punch is significantly smaller than the final joint. This opens an option of leaving part of the virgin material untouched by the punch in the preforming phase. This may open a way of creating flat joints.

It would be possible to change the angle of attack of the punch. It may in fact be beneficial for the punch to attack the surface at an angle with respect to the plane of the drawing either biting into or having the axis trailing. This means that the axis 9 and axis 12 will not cross.

The punch 6 can be rotated by means of a motor synchronised with the movement of the punch holder so that there will be no friction between the sheet formed members and the punch or overspeeding in order to create heat at the joint to facilitate the forming of the same.

FIG. 6

FIG. 6 shows the invention applied to a machine of known type with a C-frame. A mechanism 13 is shematically illustrated. this mechanism is arranged to move and lock the anvil.

It should be noted the top of the punch e.g. could have the form of a cone or be flat or rounded.

In the embodiments according to FIG. 4 and 5 there is no risk that the punch will be squeezed in the hole.

1. Method for mechanical joining two or more sheet formed members in which the sheet formed members are positioned overlapping over a die and a punch is moved in the direction of the die in order to draw the sheet formed material down into the die thereby forming a cup formed cavity characterised in that the punch axis forms an angle with the geomertical axis of the die and that the punch creates the lateral expansion of the joint outside the die cavity.
